(19) United States
(12) Patent Application Publication
(10) Pub. No.: US 2008/0320408 A1
(43) Pub. Date: Dec. 25, 2008

(54) Devices, Systems, and Methods Regarding Machine Vision User Interfaces

(76) Inventor: Joseph J. Dziezanowski, Salisbury, NH (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/142,357

(22) Filed: Jun. 19, 2008

Related U.S. Application Data
(60) Provisional application No. 60/945,400, filed on Jun. 21, 2007.

(51) Int. Cl. G06F 3/048

(52) U.S. Cl. 715/771

(57) ABSTRACT

Certain exemplary embodiments can provide a method, which can comprise, via a coordinator sub-process of a machine vision user interface process, causing a user interface of a machine vision system to be defined. The machine vision user interface process can comprise a plurality of components. The coordinator sub-process can be adapted to provide a set of software objects to one or more of the components.

### CROSS-REFERENCE TO RELATED APPLICATIONS

This application claims priority to, and incorporates by reference herein in its entirety, pending U.S. Provisional Patent Application Ser. No. 60/945,400 (Attorney Docket No. 2007P12956US), filed Jun. 21, 2007.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a block diagram of an exemplary embodiment of a system 1000;

FIG. 2 is a block diagram of an exemplary set of user interface icons 2000;

FIG. 3 is an exemplary embodiment of a user interface 3000;

FIG. 4 is a block diagram of an exemplary set of user interface icons 4000;

FIG. 5 is an exemplary embodiment of a user interface 5000;

FIG. 6 is a flowchart of an exemplary embodiment of a method 6000; and

FIG. 7 is a block diagram of an exemplary embodiment of an information device 7000.

### DETAILED DESCRIPTION

Certain exemplary embodiments can provide a method, which can comprise, via a coordinator sub-process of a machine vision user interface process, causing a user interface of a machine vision system to be defined. The machine vision user interface process can comprise a plurality of components. The coordinator sub-process can be adapted to provide a set of software objects to one or more of the components.

The deployment of a machine vision application can involve a creation and/or integration of a customized user interface for the purpose of monitoring and/or control. Such a user interface can be constructed by positioning visual elements on a series of forms, and then writing code to connect the elements together.

Reducing custom coding, used in defining and/or generating the user interface, as much as possible can be desirable. Certain exemplary embodiments can provide a relatively flexible “multi-view” control system and method in a near-zero configuration framework.

Embodying user interface elements in a user interface can be a significant task for a user/programmer. As an example, a series of buttons can be displayed to allow a selection of camera views, and a programmer can handle a button press event by calling a method of a viewing control in order to render image information.

Buttons might need to be enabled or disabled under various circumstances and/or might need to be displayed when depressed by a user to show that a mode has been engaged.

Certain exemplary embodiments can provide a framework adapted for use by various user interface elements in order to attempt to simplify programming of such an interface. In certain exemplary embodiments, the amount of user coding can be reduced to near zero. Further, a multi-view control can permit a display of results of multiple inspections across multiple devices. Exemplary results can comprise images, result data, timing information, and/or input/output (I/O) states, etc. By setting control properties, the user can select between many possible viewing possibilities. Entire functional areas can be shown or hidden.

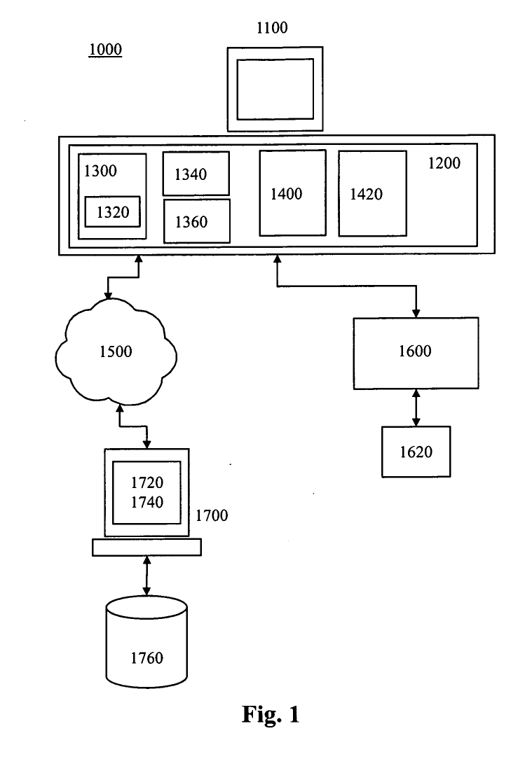

FIG. 1 is a block diagram of an exemplary embodiment of a system 1000, which can comprise an information device 1100, an imaging system 1600, a camera 1620, a network 1500, and a server 1700. Information device 1100 can be communicatively coupled to imaging system 1600 either directly, as illustrated, or via network 1500. Imaging system 1600 can be communicatively coupled to, and/or comprise, camera 1620. Certain exemplary systems can comprise a plurality of machine vision systems and/or a plurality of cameras. Server 1700 can be communicatively coupled to imaging system 1600, either via information device 1100, or via network 1500 without involvement of information device 1100. In certain exemplary embodiments, imaging system 1600 can be a machine vision system adapted to read one or more marks. The one or more marks can be data matrix marks and/or direct part marks that comprise information regarding an object. Any of numerous other imaging algorithms and/or results can be used and/or analyzed via system 1000.

Information device 1100 can comprise a machine vision user interface process 1200, which can be adapted to define, generate, coordinate, and/or provide machine-implementable instructions for a user interface regarding machine vision system 1600. Machine vision user interface process 1200 can comprise and/or be communicatively coupled to a coordinator processor 1300, a first object 1340, a second object 1360, a first component 1400, and a second component 1420.

Although two objects and two components are illustrated, system 1000 can comprise any number of objects and components in order to define, generate, coordinate, and/or provide a user interface.

Coordinator processor 1300 can comprise and/or be adapted to execute a coordinator sub-process 1320. In certain exemplary embodiments, functional characteristics of coordinator sub-process 1320 can be implemented directly in first component 1400 and second component 1420 without a separate and distinct coordinator sub-process 1320.

Coordinator processor 1300 can be adapted to cause a user interface of a machine vision system (e.g., imaging system 1600) to be defined and/or coordinated.

Coordinator processor 1300 can be adapted to provide a set of software objects, such as first object 1340 and second object 1360, to one or more components of machine vision user interface process 1200, such as first component 1400 and second component 1420. Each of the set of software objects, when executed, can be adapted to automatically coordinate and/or define a corresponding user interface element. Coordinator processor 1300 can be adapted to allow only a single instance of each object in machine vision user interface process 1200.

Coordinator processor 1300 can be adapted to notify each component of machine vision user interface process 1200 that executes a selected object, such as first object 1340, when a selected component, such as first component 1400, of machine vision user interface process 1200 executes the selected object. The selected object can be one of the set of software objects.

The set of software objects can comprise a symbolic function object adapted to, based upon a first user selection of a first toolbar button of the user interface, automatically enable or disable the first toolbar button. The set of software objects can comprise a device selection object adapted to coordinate a first user interface element that renders a list of machine vision devices that can be adapted to cause an image of an item, information regarding the image of the item, and/or information derived from the image of the item to be obtained. A user selection of a determined machine vision device from the list can be adapted to cause the determined machine vision device to be used to obtain the image of the item, information regarding the image of the item, and/or information derived from the image of the item.

The set of software objects can comprise a viewing control object that can be adapted to coordinate a user interface element. The user interface element can be adapted to render images based upon a user selection. The images can be obtained via the machine vision system (e.g., imaging system 1600). The set of software objects can comprise a report control object that can be adapted to coordinate a user interface element. The user interface element can be adapted to cause inspection results regarding machine vision hardware, firmware, and/or software to be rendered. The set of software objects can comprise a chart control object adapted to coordinate a user interface element that renders timing information and/or other information, such as a position and/or intensity value of a selected device of the machine vision system. The set of software objects can comprise a group control object, which can be adapted to allow two or more devices of the machine vision devices to be grouped such that all devices in a group are viewed in a same user interface.

One or more functions performed via information device 1100 can be performed and/or reported to server 1700. Server 1700 can comprise a user interface 1720, a user program 1740, and a memory device 1760. User interface 1720 can be adapted to monitor and/or control one or more functions of imaging system 1600.

User program 1740 can comprise machine vision user interface process 1200 and/or one or more functions performed thereby. Memory device 1760 can be adapted to store machine-implementable instructions and/or data regarding imaging system 1600.

Coordinator sub-process 1320 can be adapted to implement at least one object as a “process singleton”, i.e., allowing only a single instance of the object to exist in a current process. When various components request an instance of the selected object, the components can each obtain a reference to the same object. When one component calls a method of the selected object, all other components that use the selected object can be identified and/or notified.

As an example, a user interface can have a drop-down control from which to select a device, a viewing control that can display images (i.e. multi-view control), a report control that can show inspection results, and/or a chart control that can display timing data, etc. One or more such controls can be placed on a form by the user/programmer. Coordinator sub-process 1320 can cause a coordination of a user interface that is functional substantially without the user writing code. When a device is selected from the drop-down control, the display control can show image information obtained via the device, the report control can show the inspection results, and/or the chart control can show timing for the selected device, etc.

Certain exemplary embodiments can be adapted to group controls such that controls can be used as independent sets. In the above example, groups can be used to view two or more devices within the same user interface. Groups can be created by assigning the same GroupID property to each of the controls in the group. Certain exemplary embodiments might not utilize additional programming.

Coordinator sub-process 1320 can make objects available to one or more components specified by the user, so that customized solutions can be created. The following are functions comprised by exemplary objects:
Device List—a list of all available devices and a current state of each;
Device Focus—indicative of a currently selected device for a particular group that, when set to a particular device, can automatically connect elements with the same GroupID to the device;
Symbolic Functions—“functions” can be created and assigned symbolic names via a function creator, which can be called back whenever the function is invoked. A list of functions can be maintained by coordinator sub-process 1320. Any object provided by coordinator sub-process 1320 can invoke any defined function, even if implemented in another module or control. Functions can comprise a value, enabled status, and/or highlight status, etc.; and/or
Broadcast Messages—can allow a component that uses a selected object to send a message to another component that also uses the selected object.

In certain exemplary embodiments, a device selection component can automatically engage the multi-view control to display images and other data. The user can place both controls on a form, substantially without performing other coding, in order to define a user interface.

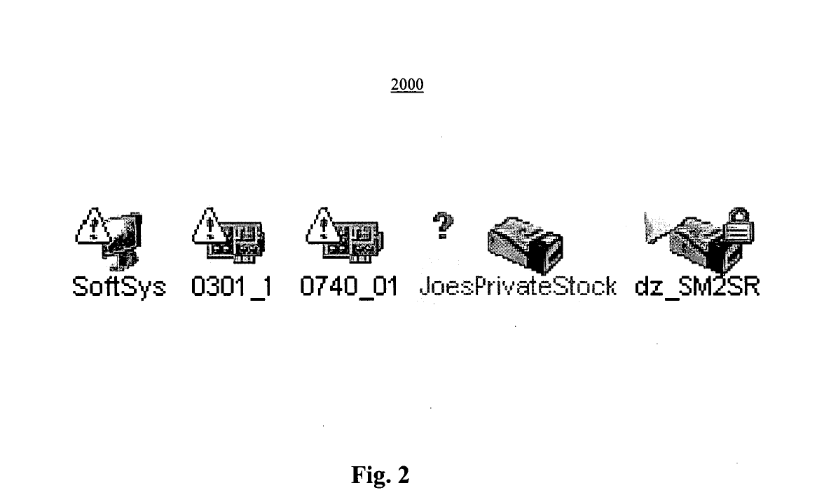

FIG. 2 is a block diagram of an exemplary set of user interface icons 2000, which can comprise automatically detected icons indicative of a device list of an imaging system. In certain exemplary embodiments, the user can place a device selection control on a form, which can be automatically populated with devices by an object provided by a coordinator sub-process. The user can select a device via the device list, from which image information can be obtained.

The user can place a multi-view control on the form. Substantially without performing additional coding, the application comprising the multi-view control can be executable by the user. When a user interface comprising user interface icons 2000 is rendered, the user can select one of the icons and/or press a button associated with one of the icons on device selection control. An embedded coordinator sub-process can provide an associated device object, which can be called dev.

The device selection component can call Coordinator.SetDeviceFocus (dev). The coordinator sub-process can raise an event called OnDeviceFocus. Since all “instances” of the object in the current process can be the same object, all the other components that use the object can receive a notification regarding the event. Certain exemplary embodiments can include the multi-view control. The Multi-view control can receive the OnDeviceFocus event and the associated dev object. Using a communications library, the multi-view control can make one or more TCP and UDP connections to the device for the purpose of receiving image and result data from dev. In certain exemplary embodiments, the device can be directly connected to an information device without a network therebetween. For example the device can be resident in a Peripheral Connect Interface (PCI) bus of an information device.

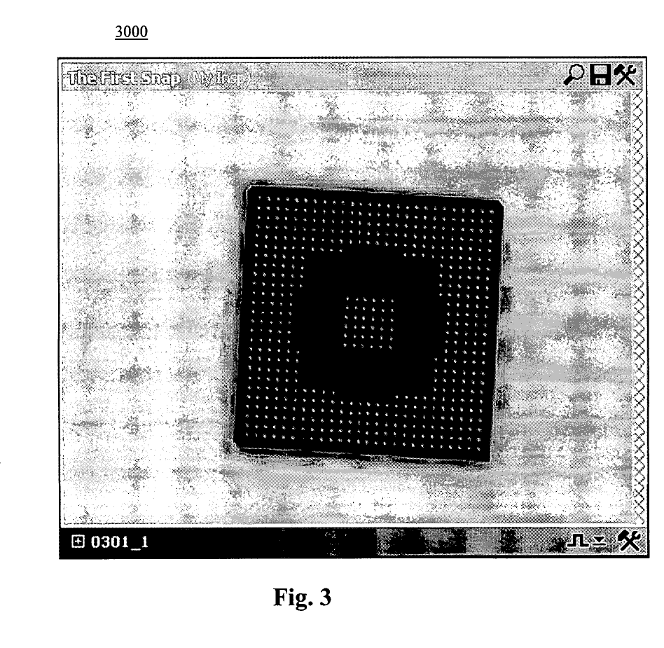

FIG. 3 is an exemplary embodiment of a user interface 3000, which can comprise data and/or images of the multi-view control.

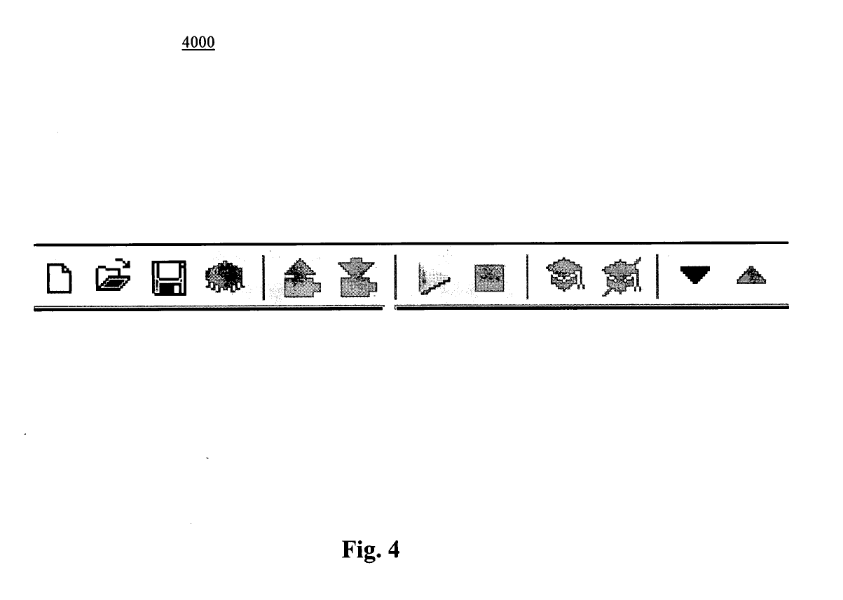

FIG. 4 is a block diagram of an exemplary set of user interface icons 4000, which can be illustrative of a symbolic function feature provided by the coordinator sub-process. The symbolic function feature can be used to enable or disable toolbar buttons. The user can place a device selection control on a form and/or on a toolbar to perform various functions that can be implemented by various object enabled controls. Each of buttons on the toolbar can be assigned a tag corresponding to a symbolic name of an implemented function (e.g. “StartInspection”, “StopInspection”, etc).

For each button the Coordinator.GetFunction method can be called with the symbolic name. The Coordinator.GetFunction method can be adapted to return a Function object that comprises information about whether a selected button should be enabled, disabled, visible, and/or shown as depressed.

If a toolbar is used that utilizes the coordinator sub-process, the user might not perform any coding. If instead a custom toolbar and/or other buttons are used, the user can provide instructions to call the Coordinator.GetFunction method, which might involve providing a relatively small amount of code.

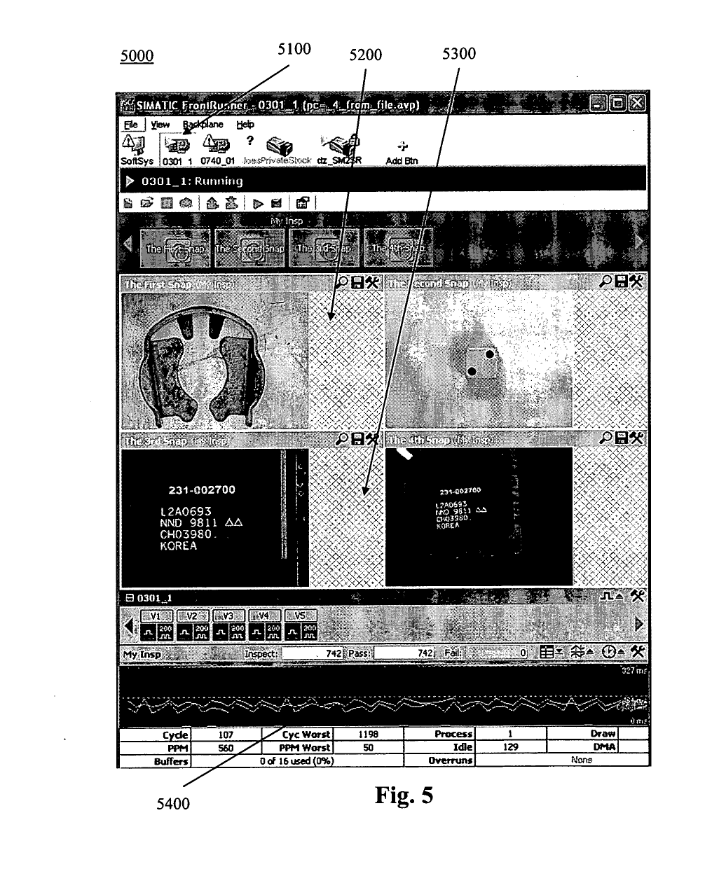

FIG. 5 is an exemplary embodiment of a user interface 5000, which can comprise a set of device selection buttons 5100, a first multi-view control panel 5200, a second multi-view control panel 5300, and a chart/report panel 5400. Each of set of device selection buttons 5100, first multi-view control panel 5200, second multi-view control panel 5300, and chart/report panel 5400 can be rendered responsive to corresponding objects adapted to provide a majority of code for set of device selection buttons 5100, multi-view control panel 5200, second multi-view control panel 5300, and chart/report panel 5400. First multi-view control panel 5200 can provide a pair of images and/or image information from a corresponding grouped pair of image devices and/or systems. Second multi-view control panel 5300 can provide a pair of images and/or image information from a corresponding grouped pair of image devices and/or systems. Chart/report panel 5400 can provide tabular and/or graphical information regarding an inspection associated with an imaging device and/or system that are selected by the user.

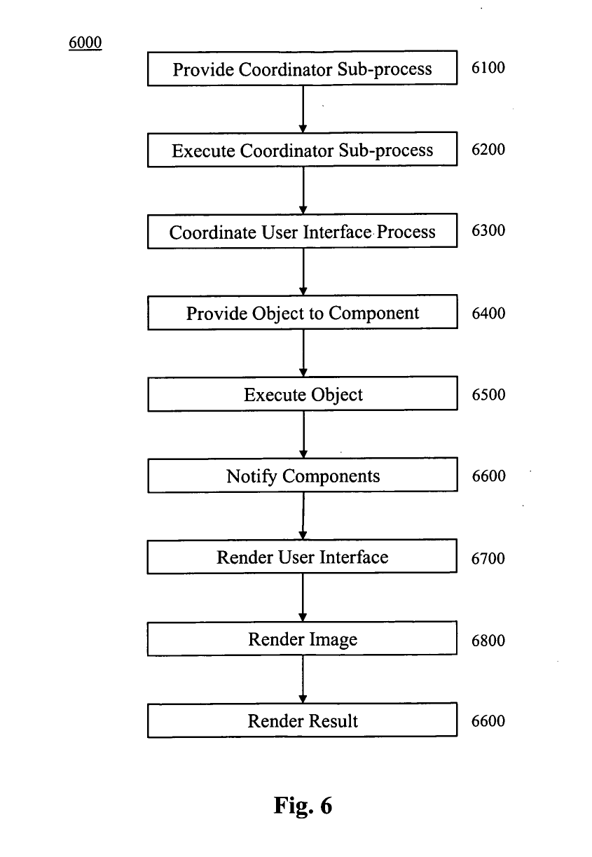

FIG. 6 is a flowchart of an exemplary embodiment of a method 6000. Each activity and/or subset of activities of method 6000 can be performed automatically by machine-implementable instructions. The machine-implementable instructions can be stored on a machine readable medium such as a memory device. At activity 6100, a coordinator sub-process can be provided.

The coordinator sub-process can be adapted to provide a set of software objects to a user interface process, such as a machine vision user interface process. Each of the set of software objects, when executed, can be adapted to automatically coordinate and/or define a corresponding user interface element used by the machine vision user interface process.

At activity 6200, the coordinator sub-process can be executed. The coordinator sub-process can be adapted to allow only a single instance of each object in the machine vision user interface process.

At activity 6300, a user interface process can be coordinated and/or defined by the coordinator sub-process. Via the coordinator sub-process of a machine vision user interface process, a user interface of a machine vision system can be defined and/or coordinated. The machine vision user interface process can comprise a plurality of components. Certain exemplary embodiments can be adapted to cause the user interface to be defined and/or coordinated.

At activity 6400, an object of the set of objects can be provided to a selected component. The object can be modular and might not utilize any additional user-provided code. The set of software objects can comprise a device selection object adapted to coordinate a first user interface element that renders a list of machine vision devices that can be adapted to cause an image of an item to be obtained. A user selection of a determined machine vision device from the list can be adapted to cause the determined machine vision device to be used to obtain the image of the item, image information regarding the item, and/or information derived from the image, etc.

The set of software objects can comprise a group control object adapted to allow two or more devices of the machine vision devices to be grouped such that images obtained from all devices in a group can be viewed in a same user interface. The set of software objects can comprise a viewing control object adapted to coordinate a second user interface element. The second user interface element can be adapted to render the images of items and/or information regarding the images based upon a user selection.

The set of software objects can comprise a symbolic function object that can be adapted to, based upon a user selection of a toolbar button of the user interface, automatically enable or disable the toolbar button. The set of software objects can comprise a report control object, which can be adapted to coordinate a third user interface element. The third user interface element can be adapted to cause inspection results regarding machine vision hardware, firmware, and/or software to be rendered. The set of software objects can comprise a chart control object, which can be adapted to coordinate a fourth user interface element. The fourth user interface element can render timing information of a selected device of the machine vision system.

At activity 6500, the object can be executed by the selected component. The coordinator sub-process can be adapted to determine that components of the user interface process other than the selected component use the object.

At activity 6600, other components that use the object other than the selected component can be notified that the selected component is executing the object.

The coordinator sub-process can be adapted to notify each component that is adapted to execute a selected object when a selected component executes the selected object. The selected object can be one of the set of software objects.

At activity 6700, a user interface can be rendered based upon a definition established by the coordinator sub-process and/or a set of objects used to generate elements of the user interface. The user interface can comprise a set of control icons and/or panels associated with the machine vision system.

At activity 6800, an image and/or information associated with the image can be rendered via the user interface. The user interface can comprise a panel via which the image and/or information associated with the image can be rendered for one or more devices of the machine vision system.

At activity 6900, a result of analyzing an image can be rendered. In certain exemplary embodiments, the result can be related to a mark associated with the object, which can be read and/or decoded. The mark can be indicative of one or more characteristics of the object.

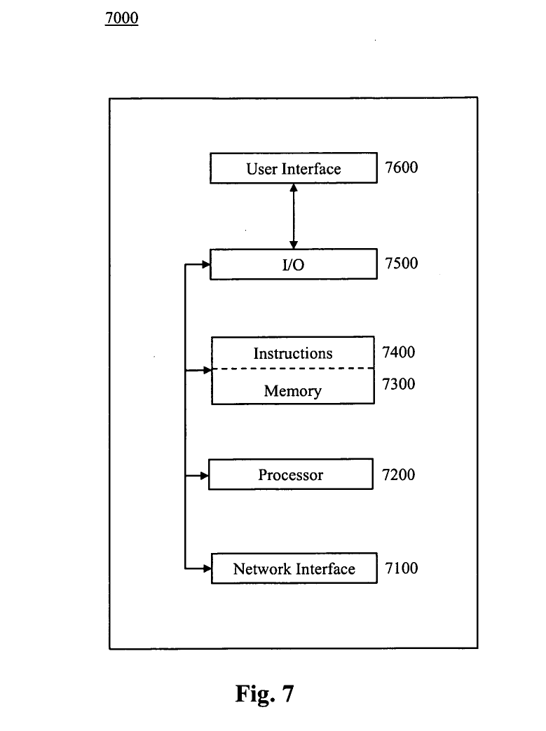

FIG. 7 is a block diagram of an exemplary embodiment of an information device 7000, which in certain operative embodiments can comprise, for example, information device 1100 and server 1700 of FIG. 1. Information device 7000 can comprise any of numerous circuits and/or components, such as for example, one or more network interfaces 7100, one or more processors 7200, one or more memories 7300 containing instructions 7400, one or more input/output (I/O) devices 7500, and/or one or more user interfaces 7600 coupled to I/O device 7500, etc.

In certain exemplary embodiments, via one or more user interfaces 7600, such as a graphical user interface, a user can view a rendering of information related to researching, designing, modeling, creating, developing, building, manufacturing, operating, maintaining, storing, marketing, selling, delivering, selecting, specifying, requesting, ordering, receiving, returning, rating, and/or recommending any of the products, services, methods, and/or information described herein.

### DEFINITIONS

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapted to—suitable, fit, and/or capable of performing a specified function.
all—every one.
allow—to provide, let do, happen, and/or permit.
and/or—either in conjunction with or in alternative to.
apparatus—an appliance or device for a particular purpose.
associate—to join, connect together, and/or relate.
automatically—acting and/or operating in a manner essentially independent of external human influence and/or control. For example, an automatic light switch can turn on upon “seeing” a person in its view, without the person manually operating the light switch.
based upon—determined in consideration of and/or derived from.
generate—to create, produce, render, give rise to, and/or bring into existence.
can—is capable of, in at least some embodiments.
cause—to bring about, provoke, precipitate, produce, elicit, be the reason for, result in, and/or effect.
chart—a pictorial device used to illustrate quantitative relationships.
chart control object—a set of machine-implementable instructions associated with rendering graphical information regarding a machine vision system.
component—a set of machine-implementable instructions adapted to perform a predefined service, respond to a predetermined event, and/or communicate with at least one other component.
comprise—to include but not be limited to.
configure—to make suitable or fit for a specific use or situation.
control—(n) a mechanical or electronic device used to operate a machine within predetermined limits; (v) to exercise authoritative and/or dominating influence over, cause to act in a predetermined manner, direct, adjust to a requirement, and/or regulate.
convert—to transform, adapt, and/or change.
coordinate—to manage, regulate, adjust, and/or combine programs, procedures, and/or actions to attain a result.
coordinator sub-process—a set of machine-implementable instructions adapted to manage a set of software objects of a machine vision process.
corresponding—related, associated, accompanying, similar in purpose and/or position, conforming in every respect, and/or equivalent and/or agreeing in amount, quantity, magnitude, quality, and/or degree.
create—to bring into being.
data—distinct pieces of information, usually formatted in a special or predetermined way and/or organized to express concepts.
define—to specify and/or establish the content, outline, form, and/or structure of.
determine—to obtain, calculate, decide, deduce, and/or ascertain.
device—a machine, manufacture, and/or collection thereof.
disable—to render incapable of performing a task.
each—every one of a group considered individually.
element—a component of a user interface.
enable—to render capable for a task.
execute—to carry out a computer program and/or one or more instructions.
firmware—a set of machine-readable instructions that are stored in a non-volatile read-only memory, such as a PROM, EPROM, and/or EEPROM.
first—an initial cited element of a set.
function—(n) a defined action, behavior, procedure, and/or mathematical relationship. (v) to perform as expected when applied.
further—in addition.
generate—to create, produce, give rise to, and/or bring into existence.
group—(n.) a number of individuals or things considered together because of similarities; (v.) to associate a number of individuals or things such that they are considered together and/or caused to have similar properties.
group control object—a set of machine-implementable instructions adapted to cause a first device of a machine vision system to be associated with at least a second device of the machine vision system.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
hardware—mechanical, magnetic, optical, electronic, and/or electrical components making up a system such as an information device.
image—an at least two-dimensional representation of an entity and/or phenomenon.
information—facts, terms, concepts, phrases, expressions, commands, numbers, characters, and/or symbols, etc., that are related to a subject. Sometimes used synonymously with data, and sometimes used to describe organized, transformed, and/or processed data. It is generally possible to automate certain activities involving the management, organization, storage, transformation, communication, and/or presentation of information.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
initialize—to prepare something for use and/or some future event. input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
inspect—to examine.
instance—an occurrence of something, such as an actual usage of an individual object of a certain class. Each instance of a class can have different values for its instance variables, i.e., its state.
item—a single article of a plurality of articles.
list—a series of words, phrases, expressions, equations, etc. stored and/or rendered one after the other. machine readable medium—a physical structure from which a machine, such as an information device, computer, microprocessor, and/or controller, etc., can obtain and/or store data, information, and/or instructions. Examples include memories, punch cards, and/or optically-readable forms, etc.
machine-implementable instructions—directions adapted to cause a machine, such as an information device, to perform one or more particular activities, operations, and/or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine vision—a technology application that uses hardware, firmware, and/or software to automatically obtain image information, the image information adapted for use in performing a manufacturing activity.
machine vision user interface process—a set of machine-implementable instructions adapted to automatically define a user interface of a machine vision system.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
more—greater.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, Ethernet card, cable modem, digital subscriber line interface, bridge, hub, router, or other similar device.
notify—to advise and/or remind.
object—an allocated region of storage that contains a combination of data and the instructions that operate on that data, making the object capable of receiving messages, processing data, and/or sending messages to other objects.
obtain—to receive, get, take possession of, procure, acquire, calculate, determine, and/or compute.
one—a single unit.
only—substantially without any other.
packet—a discrete instance of communication.
plurality—the state of being plural and/or more than one.
predetermined—established in advance.
process—(n.) an organized series of actions, changes, and/or functions adapted to bring about a result. (v.) to perform mathematical and/or logical operations according to programmed instructions in order to obtain desired information and/or to perform actions, changes, and/or functions adapted to bring about a result.
processor—a hardware, firmware, and/or software machine and/or virtual machine comprising a set of machine-readable instructions adaptable to perform a specific task. A processor can utilize mechanical, pneumatic, hydraulic, electrical, magnetic, optical, informational, chemical, and/or biological principles, mechanisms, signals, and/or inputs to perform the task(s). In certain embodiments, a processor can act upon information by manipulating, analyzing, modifying, and/or converting it, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application ©Specific Integrated Circuit (ASIC) or a Field Programmable Gate Array (FPGA) that has been designed to implement in its hardware and/or firmware at least a part of an embodiment disclosed herein. A processor can reside on and use the capabilities of a controller.
provide—to furnish, supply, give, convey, send, and/or make available.
receive—to get as a signal, take, acquire, and/or obtain.
regarding—pertaining to.
render—to display, annunciate, speak, print, and/or otherwise make perceptible to a human, for example as data, commands, text, graphics, audio, video, animation, and/or hyperlinks, etc., such as via any visual, audio, and/or haptic mechanism, such as via a display, monitor, printer, electric paper, ocular implant, cochlear implant, speaker, etc.
repeatedly—again and again; repetitively.
report—(n.) a presentation of information in a predetermined format; (v.) to present information in a predetermined format. report control object—a set of machine-implementable instructions associated with rendering information associated with a machine vision system. request—to express a desire for and/or ask for. result—an outcome and/or consequence of a particular action, operation, and/or course.
said—when used in a system or device claim, an article indicating a subsequent claim term that has been previously introduced.
second—a cited element of a set that follows an initial element.
select—to make a choice or selection from alternatives.
selection—a choice.
set—a related plurality of predetermined elements; and/or one or more distinct items and/or entities having a specific common property or properties.
single—existing alone or consisting of one entity.
software—instructions executable on a machine and/or processor to create a specific physical configuration of digital gates and machine subsystems for processing signals.
store—to place, hold, and/or retain data, typically in a memory.
substantially—to a great extent or degree.
such that—in a manner that results in.
symbolic function object—a set of machine-implementable instructions adapted to cause a change in an element of a user interface.
system—a collection of mechanisms, devices, machines, articles of manufacture, processes, data, and/or instructions, the collection designed to perform one or more specific functions.
timing information—data pertaining to temporal characteristics and/or activities of a system.
toolbar button—a portion of a user interface that when selected by an action of a user will perform a predetermined action.
transmit—to send as a signal, provide, furnish, and/or supply.
two—one plus one.
user—a person, organization, process, device, program, protocol, and/or system that uses a device, system, process, and/or service.
user interface—a device and/or software program for rendering information to a user and/or requesting information from the user. A user interface can include at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc.

A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
user interface element—This can be any known user interface structure, including for example, a window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, image, icon, button, control, dial, slider, scroll bar, cursor, status bar, stepper, and/or progress indicator etc.
via—by way of and/or utilizing.
view—to see, examine, and/or capture an image of.
viewing control object—a set of machine-implementable instructions associated with obtaining and/or rendering an image.
weight—a value indicative of importance.
when—at a time.
wherein—in regard to which; and; and/or in addition to. Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive.

What is claimed is:

1. A method comprising a plurality of activities, comprising:
via a coordinator sub-process of a machine vision user interface process, said machine vision user interface process comprising a plurality of components, causing a user interface of a machine vision system to be defined, said coordinator sub-process adapted to provide a set of software objects, each of said set of software objects, when executed, adapted to automatically coordinate a corresponding user interface element, said coordinator sub-process adapted to allow only a single instance of each object in said machine vision user interface process, said set of software objects comprising a device selection object adapted to coordinate a first user interface element that renders a list of machine vision devices that are adapted to cause an image of an item to be obtained, a user selection of a determined machine vision device from said list adapted to cause said determined machine vision device to be used to obtain said image of said item, said set of software objects comprising a group control object adapted to allow two or more devices of said machine vision devices to be grouped such that images obtained from all devices in a group are viewed in a same user interface.

2. The method of claim 1, further comprising:
executing a selected object from said set of objects.

3. The method of claim 1, wherein:
said coordinator sub-process is adapted to notify each component that is adapted to execute a selected object when a selected component executes said selected object, said selected object one of said set of software objects.

4. The method of claim 1, wherein:
said set of software objects comprises a viewing control object that coordinates a second user interface element adapted to render said images of items based upon a user selection.

5. The method of claim 1, wherein:
said set of software objects comprises a symbolic function object adapted to, based upon a user selection of a toolbar button of said user interface, automatically enable said toolbar button.

6. The method of claim 1, wherein:
said set of software objects comprises a symbolic function object adapted to, based upon a user selection of a toolbar button of said user interface, automatically disable said toolbar button.

7. The method of claim 1, wherein:
said set of software objects comprises a report control object adapted to coordinate a second user interface element that is adapted to cause inspection results regarding machine vision hardware to be rendered.

8. The method of claim 1, wherein:
said set of software objects comprises a report control object adapted to coordinate a second user interface element that is adapted to cause inspection results regarding machine vision firmware to be rendered.

9. The method of claim 1, wherein:
said set of software objects comprises a report control object adapted to coordinate a second user interface element that is adapted to cause inspection results regarding machine vision software to be rendered.

10. The method of claim 1, wherein:
said set of software objects comprises a chart control object adapted to coordinate a second user interface element that renders timing information of a selected device of said machine vision system.

11. A machine-readable medium comprising machine-implementable instructions for activities comprising:
via a coordinator sub-process of a machine vision user interface process, causing a user interface of a machine vision system to be defined, said coordinator sub-process adapted to provide a set of software objects, each of said set of software objects, when executed, adapted to automatically coordinate a corresponding user interface element, said coordinator sub-process adapted to allow only a single instance of each object in said machine vision user interface process, said set of software objects comprising a symbolic function object adapted to, based upon a user selection of a toolbar button of said user interface, automatically disable said toolbar button, said set of software objects comprising a device selection object adapted to coordinate a first user interface element that renders a list of machine vision devices that are adapted to cause an image of an item to be obtained, a user selection of a determined machine vision device from said list adapted to cause said determined machine vision device to be used to obtain said image of said item.

12. A system, comprising:
a coordinator processor adapted to cause a user interface of a machine vision system to be defined, said coordinator processor adapted to provide a set of software objects, each of said set of software objects, when executed, adapted to automatically coordinate a corresponding user interface element, said coordinator processor adapted to allow only a single instance of each object in a machine vision user interface process, said set of software objects comprising a symbolic function object adapted to, based upon a first user selection of a first toolbar button of said user interface, automatically enable said first toolbar button, said set of software objects comprising a device selection object adapted to coordinate a first user interface element that renders a list of machine vision devices that are adapted to cause an image of an item to be obtained, a user selection of a determined machine vision device from said list adapted to cause said determined machine vision device to be used to obtain said image of said item.

13. The system of claim 12, further comprising:
said machine vision system.

14. The system of claim 12, wherein:
said coordinator processor is adapted to notify each component of said machine vision user interface process that executes a selected object when a selected component of said machine vision user interface process executes said selected object, said selected object one of said set of software objects.

15. The system of claim 12, wherein:
said set of software objects comprises a viewing control object that coordinates a user interface element adapted to render images based upon a user selection, said images obtained via said machine vision system.

16. The system of claim 12, wherein:
said set of software objects comprises a symbolic function object adapted to, based upon a second user selection of a second toolbar button of said user interface, automatically disable said second toolbar button.

17. The system of claim 12, wherein:
said set of software objects comprises a report control object adapted to coordinate a user interface element that is adapted to cause inspection results regarding machine vision hardware to be rendered.

18. The system of claim 12, wherein:
said set of software objects comprises a chart control object adapted to coordinate a user interface element that renders timing information of a selected device of said machine vision system.

19. The system of claim 12, wherein:
said set of software objects comprises a group control object adapted to allow two or more devices of said machine vision devices to be grouped such that all devices in a group are viewed in a same user interface.
